(19) United States
(12) Patent Application Publication
(10) Pub. No.: US 2007/0029976 A1
(43) Pub. Date: Feb. 8, 2007

(54) Method and apparatus for monitoring battery cell temperature

(76) Inventors: Jorge L. Garcia, Plantation, FL (US); Joseph Patino, Pembroke Pines, FL (US); Russell L. Simpson, Miami, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/184,687

(22) Filed: Jul. 19, 2005

(51) Int. Cl. H02J 7/04

(52) U.S. Cl. 320/150

(57) ABSTRACT

A battery pack (110) having a plurality of cells (103, 105) utilizes a pull up resistor (116) multiplexed between separate voltage supply sources (120, 122) and a single battery contact (106) to monitor individual cell temperatures. A plurality of thermistors (102, 104) are coupled in series between ground potential (108) and the single battery pack contact (106), each thermistor being coupled to one cell of the pack. Individual voltage divider circuits are formed for each thermistor (102, 104) as the pull up resistor (116) is multiplexed between the voltage supply sources (120, 122).

### TECHNICAL FIELD

This invention relates in general to battery monitoring and more particularly to the monitoring of battery cell temperature of multi-cell battery packs.

### BACKGROUND

Battery powered communication devices, such as two-way radios and cell phones, often utilize two or more battery cells within a single battery pack. Typically, a single thermistor is used to monitor cell temperature of the battery pack. The disadvantage to using a single thermistor, however, is that it can only be placed near one cell and consequently only the temperature of that cell. A thermal problem with another cell within the pack may only be detected after some delay or possibly not at all. Alternately, a thermistor may be located between the cells of a two cell pack so that the average temperature of the two cells can be monitored. However, the actual temperature of either cell is not measured.

As battery technology continues to advance, there is an ever increasing likelihood that mixed cell chemistries may exist in a single pack. Cell temperature can vary greatly depending on the cell's chemical composition. Thus, the ability to monitor individual cell temperature is highly desirable. Unfortunately, the use of additional thermistors to monitor individual cell temperature requires additional contacts which increases cost, size and manufacturing complexity.

Accordingly, it would be beneficial to improve battery cell temperature monitoring capabilities without the use of additional contacts.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a battery cell temperature monitoring system in accordance with a first embodiment of the invention.

FIG. 2 is a battery cell temperature monitoring system in accordance with a second embodiment of the invention;

FIG. 3 is a method for monitoring battery temperature of a multi-cell battery pack in accordance with the present invention; and

FIG. 4 is a communication system formed in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and shall not be limited by the embodiments shown below. It is further understood that the use of relational terms, if any, such as first, second, top and bottom, front and rear and the like are used solely for distinguishing one entity or action from another, without necessarily requiring or implying any such actual relationship or order between such entities or actions.

Briefly, there is provided herein a method and apparatus for individually monitoring the temperature of each battery cell of a multi-cell battery pack via a single contact by multiplexing multiple thermistors cascaded in series across individual cells of the pack.

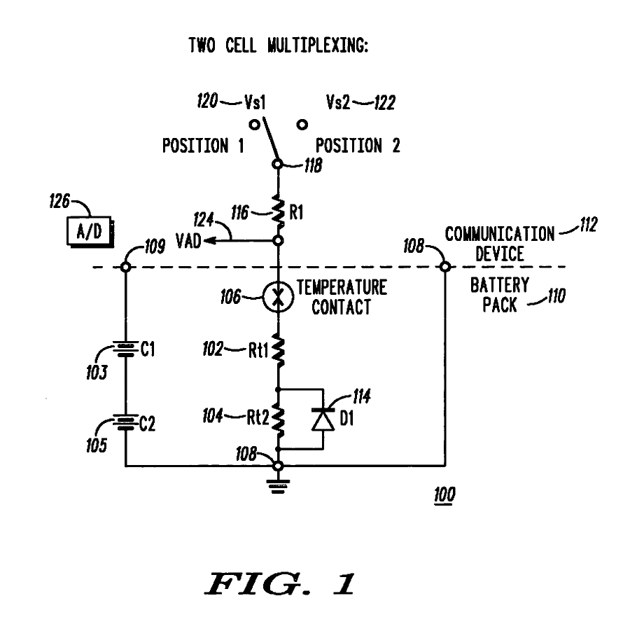

Referring to FIG. 1, there is shown a battery cell temperature monitoring system 100 formed in accordance with a first embodiment of the invention. System 100 includes a battery pack 110 and communication device 112 coupled thereto via a plurality of contacts. Battery contacts 108, 109 provide ground potential and voltage respectively to communication device 112. In accordance with the first embodiment, a single battery contact, temperature contact 106, is used in conjunction with first and second thermistors (Rt1) 102, (Rt2) 104 to monitor the temperature of first and second cells 103, 105 (C1, C2) utilizing a two cell multiplexing approach. Thermistors (Rt1) 102 and (Rt2) 104 are coupled in series between temperature contact 106 and ground potential 108 of battery pack 110. A zener diode 114 (D1) is coupled in parallel across thermistor Rt2 104 for multiplexing purposes. Each thermistor 102, 104 is located on or near each battery cell 103, 105.

On the communication device side 112, a pull-up resistor (R1)116 is switchably coupled via switch 118 to first and second voltage supply sources 120, 122 (Vs1 Vs2) respectively. The voltage sources are tapped from predetermined voltage supply sources within the communication device 112. Each voltage supply source is selected based on the individual zener diodes' breakdown voltages. As the switch 118 switches amongst the voltage supply sources, different diodes are turned on to create a unique voltage divider circuit for each thermistor for each switch position. An analog to digital converter (A/D) 126 monitors the voltage (VAD) at temperature contact 106 as the pull-up resistor 116 is multiplexed through the different voltage source points, Vs1, Vs2 120, 122.

Initially, switch 118 is in a first position connected to first voltage source (Vs1) 120, which is a less than the zener threshold voltage 114 (D1), thereby turning D1off. First voltage source voltage (Vs1) 120 is divided across the resistor R1 116 and the sum of the thermistors Rt1 102 and Rt2 104 thereby producing a voltage drop (Vad) 124 which is read by analog to digital converter 126. The sum of the thermistors can be represented by the following equation:

$$( Rt 1 + Rt 2 ) = \frac{( rR1 * Vad )}{( Vs 1 - Vad )}$$

Once the Vad value is read and the sum of the thermistors is determined, switch 118 is moved to second position and coupled to second voltage source (Vs2) 122, which is a voltage greater than the zener diode (D1) 114 voltage (Vz), thereby turning D1 on. Thermistor value Rt1 is determined using the formula:

$$Rt 1 = \frac{( Vad - Vz ) * R 1}{( Vs 2 - Vad )}$$

Once the value of Rt1 is known, it can be subtracted from the (Rt1+Rt2) value found in the initial equation to determine Rt2. The values of Rt1 and Rt2 determined above correspond to individual temperatures of cells C1 103 and C2 105. Thus, the temperature each battery cell of a multi-cell battery pack can be individually monitored via a single contact. Communication devices, such as radios, chargers, cell phones or the like, can all benefit from the temperature monitoring capability provided by the present invention.

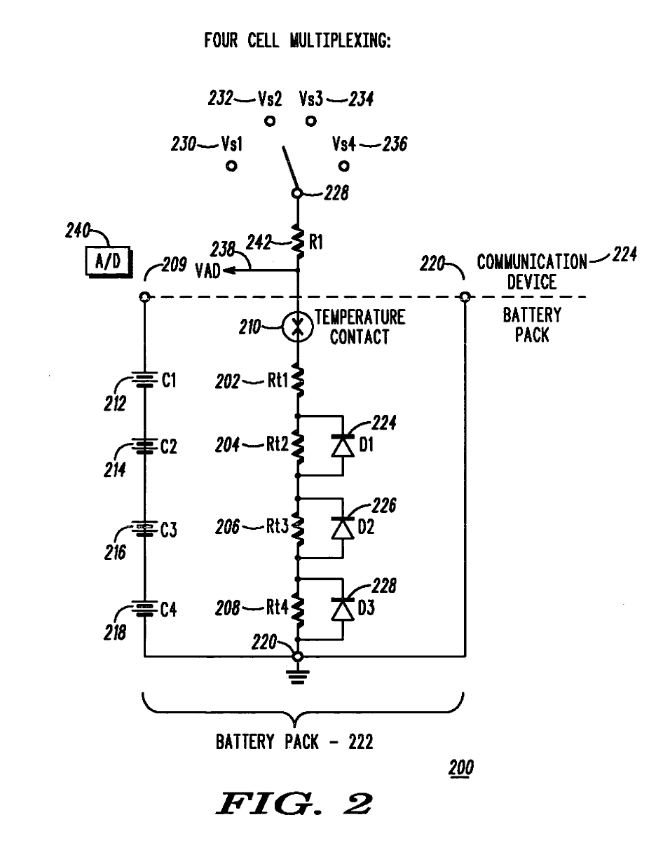

FIG. 2 shows a battery cell temperature monitoring system 200 in accordance with a second embodiment of the invention. The apparatus and technique is similar to that of FIG. 1 but expands to additional cell temperature monitoring. For the example of the second embodiment, a four cell battery pack 222 is used. In accordance with the second embodiment, temperature monitoring system 200 utilizes first, second, third and fourth thermistors (Rt1) 202, (Rt2) 204, (Rt3) 206, (Rt4) 208 in conjunction with a single battery contact, temperature contact 210, to monitor the temperature of each of four cells 212, 214, 216, 218 respectively. Thermistors (Rt1) 202, (Rt2) 204, (Rt3) 206 and (Rt4) 208 are coupled in series between temperature contact 210 and ground potential 220 of battery pack 222. Each thermistor is located near or coupled to each battery cell. Zener diodes (D1) 224, (D2) 226 (D3) 228 are coupled in parallel across thermistors (Rt2) 204, (Rt3) 206 and (Rt4) 208 respectively. Battery pack 222 is coupled via contacts 210, 220 and 209 to communication device 224.

On the communication device side 224, pull-up resistor 242 is switchably coupled via switch 228 to first, second, third and fourth voltage sources (Vs1, Vs2, Vs3, Vs4) 230, 232, 234, 236 respectively. An analog to digital converter (A/D) 240 monitors the voltage 238 at temperature contact 210 as the pull-up resistor 242 is multiplexed through the different voltage source points, Vs1, Vs2, Vs3, Vs4 230, 232, 234, 236. The thermistor values are determined as follows.

Initially, switch 228 is in the first position connected to first voltage supply source (Vs1) 230 with is less than the zener threshold voltages (D1, D2, D3), thereby turning all diodes off. First voltage source voltage (Vs1) 230 is divided across the resistor R1 242 and the sum of the values of (Rt1) 202, (Rt2) 204, (Rt3) 206, (Rt4) 208 thereby producing the voltage (Vad) 238 which is read by analog to digital converter 240. The sum of the thermistors (Rt1) 202, (Rt2) 204, (Rt3) 206, (Rt4) 208 can be determined by the following divider equation:

$$( Rt 1 + Rt 2 + Rt 3 + Rt 4 ) = \frac{( R 1 * {V}_{ad} )}{( {V}_{s 1} - {V}_{ad} )}$$

Once the Vad value is read, switch 228 is moved to second position and coupled to second voltage supply source (Vs2) 232, which is a voltage greater than the breakdown voltage of zener diode (D1) 224, thereby turning the diode D1 on. The zener voltages (D1) 224, (D2) 226, (D3) 228 are known and are represented as V₂₁, V₂₂ and V₂₃ in the equation to follow:

Thermistor value Rt1 is determined using the formula:

$$Rt 1 = \frac{( {V}_{ad} - {V}_{21} - {V}_{22} - {V}_{23} )}{( {V}_{s 2} - {V}_{ad} )} * R 1$$

Thermistor value Rt2 can be found by moving switch 228 to third voltage source (Vs3) 234. The Vs3 voltage is greater than the breakdown voltages of zener diode (D1) 224 and zener diode (D2) 226 thereby turning on these diodes. Using the known value of Rt1, thermistor value Rt2 is determined by the following formula:

$$Rt 1 + Rt 2 = \frac{( {V}_{ad} - {V}_{22} - {V}_{23} )}{( {V}_{s 3} - {V}_{ad} )} * R 1$$

Thermistor value Rt3 is determined by moving switch 228 to fourth voltage source (Vs4) 236. The Vs4 voltage is greater than the breakdown voltages of zener diode (D1) 224, zener diode (D2) 226 and zener diode (D3) 228 thereby turning on these diodes. Thermistor value Rt3 is then solved using the known values of Rt1 and Rt2 in the following formula:

$$Rt 1 + Rt 2 + Rt 3 = \frac{( {V}_{ad} - {V}_{23} )}{( {V}_{s 4} - {V}_{ad} )} * R 1$$

As seen from the embodiment of FIG. 2, individual voltage divider circuits are formed for each thermistor (202, 204, 206, 208) as the pull up resistor (242) is multiplexed between the sources (230 232, 234, 236). Any number of cells and any number of cell chemistries can now be combined within a single battery pack and still have the temperature characteristics of each individual cell monitored without additional contacts.

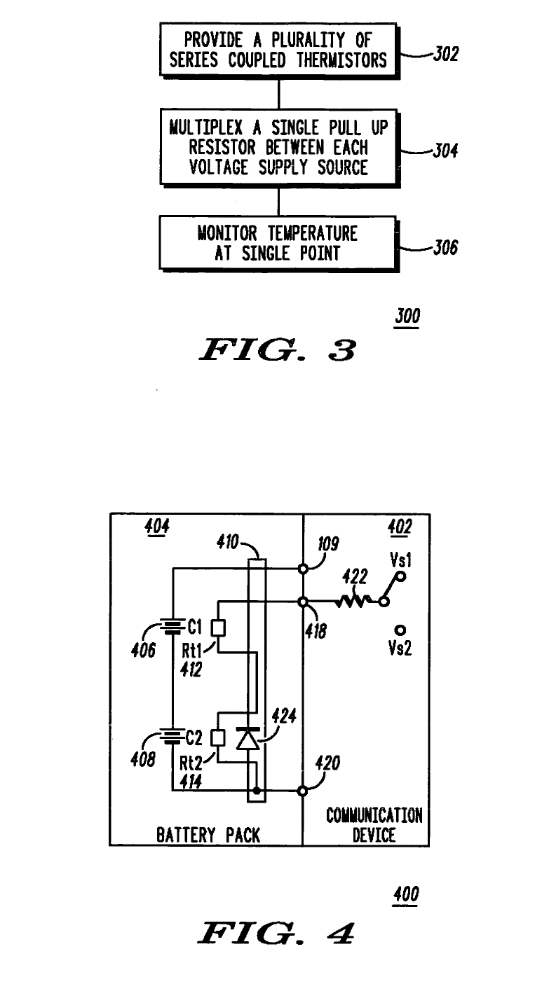

The battery temperature monitoring apparatuses described in conjunction with FIG. 1 and FIG. 2 operate with a technique shown in FIG. 3. FIG. 3 shows a flow chart depicting a method for monitoring battery temperature of a multi-cell battery pack in accordance with the present invention. Technique 300 initially provides a plurality of series coupled thermistors at step 302 with each thermistor being proximately coupled to an individual cell of a multi-cell battery pack. Next, by multiplexing a single pull up resistor between each voltage supply source and the series coupled thermistors at step 304, diode(s) are turned on or off to create unique voltage divider relationships. The temperature of each individual cell is thus capable of being determined and monitored at a single point between the single pull up resistor and the series coupled thermistors at step 306.

FIG. 4 illustrates a communication system 400 formed in accordance the present invention. Communication system 400 includes a communication device 402, such as a radio, a cell phone, a charger or other device in which battery temperature monitoring capability is desired, powered by battery pack 404. Battery pack 404 includes first and second cells 406, 408 coupled to a circuit board 410. In accordance with the invention, thermistors 412, 414 (Rt1, Rt2) are proximately coupled to cells 406, 408 respectively and are electrically coupled in series between a multiplexed pull up resistor 422 and ground potential 420. Diode 424 is coupled in parallel across thermistor Rt2 414. In accordance with the present invention, the pull up resistor 422 is multiplexed between different voltage supply sources Vs1, Vs2 turning the diode 424 on and off while an A/D reading is taken at contact 418. The value of each thermistor 412, 414 is determined using the equations previously discussed. Based on the individual thermistor values, battery cell temperature information for each cell 406, 408 is provided.

The apparatus and technique of battery temperature monitoring in accordance with the present invention allows a battery pack having two or more cells to have the individual cell temperatures monitored via a single contact. Improved temperature monitoring capability is achieved allowing for cells of differing chemistries to be used in a signal battery pack.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for monitoring battery temperature of a multi-cell battery pack, comprising:
providing a plurality of series coupled thermistors, each thermistor being proximately coupled to an individual cell of the multi-cell battery pack;
multiplexing a single pull up resistor between a plurality of voltage supply sources and the series coupled thermistors thereby providing individual voltage divider circuits for each thermistor; and
monitoring temperature of each individual cell at a single point between the single pull up resistor and the series coupled thermistors.

2. The method of claim 1 wherein the step of multiplexing further includes turning at least one diode on and off to create individual voltage divider circuits as the pull up resistor is multiplexed.

3. A battery pack temperature monitoring apparatus, comprising:
a battery pack formed of first and second cells;
first and second thermistors electrically coupled in series, the first thermistor coupled to a single battery contact, and the second thermistor coupled to ground potential, the first thermistor being proximately coupled to the first cell and the second thermistor being proximately coupled to the second cell;
a diode coupled in parallel to the second thermistor;
first and second voltage supply sources; and
a pull up resistor coupled to the to the single battery contact, the pull up resistor being multiplexed between first and second voltage supply sources such that thermistor readings of each cell are made at the single contact.

4. A battery pack temperature monitoring apparatus as described in claim 3, wherein the diode is turned on and off in response to the first and second voltage supply sources so as to create unique voltage divider circuits for the first and second thermistors.

5. A battery pack temperature monitoring apparatus as described in claim 3, wherein the first and second cells are formed of different battery chemistries.

6. A communication system, comprising:
a communication device comprising:
a plurality of voltage sources;
a pull up resistor;
a switch for multiplexing the pull up resistor amongst the plurality of voltage sources;
a battery pack comprising:
a plurality of cells;
a single battery pack contact coupled to the switch;
a plurality of thermistors coupled in series between ground potential and the single battery pack contact, one thermistor for each cell of the plurality of cells; and
the single battery pack contact providing temperature monitoring capability for each of the plurality of thermistors in response to the switch multiplexing the pull up resistor amongst the plurality of voltage sources.

7. The communication system of claim 6, wherein unique voltage divider relationships are created in response to the pull up resistor being multiplexed across the plurality of voltage sources.

8. The communication system of claim 7, further comprising a plurality of diodes responsive to the pull up resistor being multiplexed across the plurality of voltage sources to form the unique voltage divider relationships.

9. The communication system of claim 6, wherein each of the plurality of thermistors is proximately coupled to an individual battery cell of the plurality of cells.

10. The communication system of claim 6, wherein the plurality of cells are formed of different chemistries.

11. The communication system of claim 6 wherein the communication device comprises one of: a radio, a charger and a cell phone.
